(19) United States
(12) Patent Application Publication
(10) Pub. No.: US 2025/0250457 A1
(43) Pub. Date: Aug. 7, 2025

(54) COATING COMPOSITION AND USE THEREOF

(71) Applicants: DOW SILICONES CORPORATION, Midland, MI (US); DOW GLOBAL TECHNOLOGIES LLC, Midland, MI (US); ROHM AND HAAS COMPANY, Collegeville, PA (US)

(72) Inventors: Milton H. REPOLLET PEDROSA, Midland, MI (US); Jeremy BEEBE, Midland, MI (US); David HAGAN, Midland, MI (US); Rebecca BEESON, Midland, MI (US); Juan F. CALLEJAS, Collegeville, PA (US)

(21) Appl. No.: 18/861,728

(22) PCT Filed: May 2, 2023
(86) PCT No.: PCT/US2023/020636

§ 371 Date: Oct. 30, 2024

Related U.S. Application Data
(60) Provisional application No. 63/337,236, filed on May 2, 2022.

(51) Int. Cl. C09D 133/04; C08F 2/24; C08J 3/05; C09D 5/02; C09D 7/65; C09D 7/80

(52) U.S. Cl. CPC C09D 133/04; C08F 2/24; C08J 3/05; C09D 5/024; C09D 7/65; C09D 7/80; C08J 2315/00

(57) ABSTRACT

This disclosure relates to improvements in water-borne (meth)acrylic coating compositions, and resulting coatings made using said compositions by the introduction of pre-cross-linked silicone rubber microparticles to enhance water resistance and water vapor permeance of (meth)acrylic binders while improving color retention properties when compared with silicone water-borne coatings. Additionally, when compared to commercially available water-borne silicone coatings, the technology shows improved shelf-life and better film formation leading to improved dirt pickup resistance and color retention.

This disclosure relates to improvements in water-borne (meth)acrylic coating compositions, and resulting coatings made using said compositions by the introduction of pre-cross-linked silicone rubber microparticles to enhance water resistance and water vapor permeance of (meth)acrylic binders while improving color retention properties when compared with silicone water-borne coatings. Additionally, when compared to commercially available water-borne silicone coatings, the technology shows improved shelf-life and better film formation leading to improved dirt pickup resistance and color retention.

Binders or film formers (hereafter referred to as binders) are film forming components of coatings such as paints, which are typically mixed with solvents and a variety of additives to produce a required coating composition. In use, the coating composition is applied onto a substrate and is allowed to dry or cure whilst the solvent evaporates with the binder drying and/or coalescing into a cohesive filmic coating on the substrate surface. The binders are largely responsible for retaining the additives in the cohesive filmic coating and consequently for many of the physical properties therein such as the durability, gloss, and/or flexibility of the coating.

Such coating compositions may be split into two groups dependent on the solvent being used, solvent-borne coatings and water-borne coatings. Solvent-borne coatings are those where the solvent being utilised is an organic solvent and water-borne coatings, which are becoming increasingly preferred, are those where the solvent being used is primarily water although the latter may additionally contain small amounts of other solvents, such as glycol ethers.

There may be a wide variety of additives in such a coating composition. These may include, for the sake of example, pigments/colorants rheology modifiers, thickeners, stabilizers and the like.

Hence, a “water-borne resin binder” is a resin binder having water as the main solvent which may be water soluble, water reducible or water dispersed e.g., in an emulsion. Acrylic based resins may be utilised as water-borne resin binders and are usually provided in the form of an aqueous emulsion which when applied onto a substrate in a water-borne coating composition coalesces into a durable cohesive filmic coating as the water dries and/or evaporates. (Meth) acrylic-based resins are formed through the polymerization of the esters of acrylic or methacrylic acids along with various specialty acrylate monomers and are designed to create a durable and highly UV resistant film. Emulsions of (meth)acrylic polymeric particles, typically(meth)acrylic polymeric microparticles, in water are often referred to as (meth)acrylic latex coatings e.g., paints. Subsequent to when such compositions are applied as coatings onto substrates, the (meth)acrylic latex is allowed to dry causing binder particles to coalesce and form a continuous film as the water evaporates.

However, it has been found that conventional coating compositions containing water-borne acrylic resin binders have problems including poor water resistance and/or poor weatherability which has led to efforts to modify water-borne (meth)acrylic resin binders with silicon containing groups either during synthesis of the (meth)acrylic resins or by chemically modifying the resins after synthesis and/or to blend them with pre-prepared silicone rubber microparticles during emulsion polymerization of the (meth)acrylic resins. However, the amount of pre-prepared silicone rubber microparticles which can be incorporated in such systems has proven limited because during the emulsion polymerization of acrylics in the presence of pre-prepared silicone rubber microparticles, instead of generating single independent particles, the course of polymerization has been known to lead to undesirable crosslinking and poor polymerization kinetics. These polymerization difficulties lead the (meth)acrylic component to gelation, have high molecular weight distributions, and lower than anticipated average molecular weights resulting in hindering the ability to form a good continuous film and consequently the performance of the coating. It was found historically that the pre-prepared silicone particles couldn't be successfully introduced into the emulsion polymerisation mix before or during polymerisation in amounts of more than 10 wt. % of the binder.

There is provided herein a water-borne (meth)acrylic resin emulsion coating composition comprising
(a) a binder in an amount of from 30 to 70 wt. % of the water-borne (meth)acrylic resin emulsion coating composition comprising
   (a) (i) a (meth)acrylic resin in an amount of from 20 to 80 wt. % and
   (a) (ii) pre-prepared silicone rubber microparticles in an amount of from 20 to 80 wt. %; based on the total wt. % of (a) (i)+(a) (ii);
(b) an aqueous liquid continuous phase in an amount of from 15 to 30 wt. % of the water-borne (meth) acrylic resin emulsion coating composition;
(c) one or more surfactants in an amount of from 0.5 to 5 wt. % of the water-borne (meth) acrylic resin emulsion coating composition; and
(d) one or more additives.

The total weight (wt.) % of the water-borne (meth)acrylic resin emulsion coating composition described above is 100 wt. %. The water-borne (meth)acrylic resin emulsion coating composition is capable of forming a coating on a suitable substrate.

There is also provided a coated substrate, which substrate is coated with a coalesced film formed after application of the water-borne (meth)acrylic resin emulsion coating composition described above onto the substrate.

A method of making a water-borne (meth)acrylic resin emulsion coating composition as described above by mixing an aqueous (meth)acrylic resin emulsion comprising
a (meth)acrylic resin (a) (i), and
a suitable surfactant
in an aqueous liquid continuous phase with an aqueous dispersion of pre-prepared silicone rubber microparticles (a) (ii) comprising
said pre-prepared silicone rubber microparticles (a) (ii) in the presence of one of more suitable surfactants
in an aqueous liquid continuous phase;
   wherein one or more additives are added into either the aqueous (meth)acrylic resin emulsion, the aqueous dispersion of pre-prepared silicone rubber microparticles (a) (ii) or both prior to mixing and/or are added to the water-borne (meth)acrylic resin emulsion coating composition after said aqueous (meth)acrylic resin emulsion and said aqueous dispersion of pre-prepared silicone rubber microparticles (a) (ii) have been mixed together.

There is also provided a water-borne (meth)acrylic resin emulsion coating composition obtainable by the above process.

The use of the term “(meth)” followed by another term such as (meth) acrylate as used throughout the disclosure, is intended to mean both acrylates and methacrylates.

It was unexpectedly found that a much higher loading of pre-prepared silicone rubber microparticles can be incorporated into the water-borne (meth)acrylic resin emulsion coating composition using the above process i.e., by mixing a pre-polymerised (meth)acrylic resin emulsion with a dispersion of pre-prepared silicone rubber microparticles to form the water-borne (meth)acrylic resin emulsion coating composition as opposed to previous processes where the pre-prepared silicone rubber microparticles are introduced into the starting ingredients for the preparation of the (meth)acrylic resin (typically via emulsion polymerisation) prior to commencement of the polymerisation process or into the reaction mixture during preparation. By preparing the pre-prepared silicone rubber microparticles separately, dispersed in an aqueous liquid continuous phase (i.e., water) and then mixing the dispersion into the (meth)acrylic resin emulsion, a desired water-borne (meth)acrylic resin emulsion coating composition, which provides the aforementioned advantages, is obtained. The binder (a) comprises an amount of from 30 to 70 wt. % of the water-borne (meth)acrylic resin emulsion coating composition, alternatively 40 to 60 wt. % of the water-borne (meth)acrylic resin emulsion coating composition comprising
(a) (i) a (meth)acrylic resin in an amount of from 20 to 80 wt. % and
(a) (ii) pre-prepared silicone rubber microparticles in an amount of from 20 to 80 wt. %; based on the total wt. % of (a) (i)+(a) (ii); alternatively, binder (a) comprises
   (a) (i) a (meth)acrylic resin in an amount of from 20 to 60 wt. % and
   (a) (ii) pre-prepared silicone rubber microparticles in an amount of from 40 to 80 wt. %; based on the total wt. % of (a) (i)+ (a) (ii).

### (Meth) Acrylic Resin (a) (i)

The (meth)acrylic resin (a) (i) in the binder (a) described herein may comprise or consist of particles and/or microparticles of (meth)acrylic polymer resins. Such (meth)acrylic resin (a) (i) particles would have particle size diameter in the range of from 75 to 450 nm, alternatively from 100 to 375 nm, alternatively from 115 to 375 nm or alternatively from 150 to 300 nm. As used herein, unless otherwise indicated, the term “average particle size,” with regard to the (meth)acrylic resin (a) (i), means the particle size as determined by light scattering (LS) using a BI-90 particle size analyzer, Brookhaven Instruments Corp. (Holtsville, N.Y.).

The (meth)acrylic resin (a) (i) preferably comprises a weight average molecular weight in the range of from 200,000 to 5,000,000 g/mole, for example from 200,000 to 1,000,000 g/mole, alternatively from 200,000 to 750,000 g/mole). As used herein, unless otherwise indicated, the phrase “molecular weight” (for (meth)acrylic resin (a) (i)) refers to the weight average molecular weight as measured by gel permeation chromatography (GPC) against polystyrene (PS) standards.

The (meth)acrylic resin (a) (i) of binder (a) preferably has a glass transition temperature (Tg) in the range of from −50 to 100° C., for example from −30 to 75° C., or alternatively from −30 to 50° C. The meth) acrylic resin (a) (i) has a pH in the range of from 7 to 10, for example, from 7 to 9. As used herein, unless otherwise indicated, the term “Tg” or “glass transition temperature” of a polymer, with regard to the (meth)acrylic emulsion and components thereof, refers to the Tg of a polymer calculated by using the Fox equation (T. G. Fox, Bull. Am. Physics Soc., Volume 1, Issue No. 3, page 123 (1956).

Representative, non-limiting examples of commercially produced (meth)acrylic polymer water-borne dispersions useful for the binder of the present disclosure include those sold under the tradenames PRIMAL™ SS-640, PRIMAL™ AC-339, PRIMAL™ E-822K, UCAR™ Latex DL 420 G, PRIMAL™ AC-337 ER, PRIMAL™ CM-330, PRIMAL™ AC-285 and PRIMAL™ CM-160, RHOPLEX™ SG-10, RHOPLEX™ EI-2000, RHOPLEX™ 78 C and RHOPLEX™ EC-1741 (all available from DOW, Inc.).

Typically, the polymerization technique used to prepare the (meth)acrylic polymer resin of the water-borne (meth)acrylic resin emulsion coating composition is via emulsion polymerization, which is well known in the art (e.g., examples disclosed in U.S. Pat. Nos. 4,325,856; 4,654,397; and 4,814,373 among others).

(Meth) acrylic monomers suitable for use in the preparation of the (meth)acrylic resin (a) (i) by emulsion polymerisation include any compounds having suitable (meth)acrylic functionality, i.e., acrylate monomers and/or methacrylate monomers, such as, but not limited to, alkyl (meth) acrylates, (meth)acrylic acids, aromatic derivatives of (meth)acrylic acid, (meth) acrylamides and acrylonitrile. Typically, the alkyl (meth) acrylate monomers (also referred to herein as “alkyl esters of (meth)acrylic acid”) will have an alkyl group containing from 1 to 12, preferably about 1 to 5, carbon atoms per molecule.

Specific examples of “(meth)acrylic monomers” which may be utilised to prepare (meth)acrylic resin (a) (i) include but are not limited to methyl (meth)acrylate, ethyl (meth) acrylate, butyl (meth) acrylate, ureido (meth) acrylate, 2-ethylhexyl (meth) acrylate, 2-propylheptyl (meth) acrylate, decyl acrylate, isodecyl (meth) acrylate and neopentyl (meth) acrylate. Aryl acrylate monomers include phenyl (meth) acrylate and tolyl (meth) acrylate. Aralkyl (meth) acrylate monomers include benzyl (meth) acrylate and phenethyl (meth) acrylate. Cycloalkyl (meth) acrylate monomers include cyclohexyl (meth) acrylate, isobornyl (meth) acrylate, 1-adamatyl (meth) acrylate. Various reaction products such as butyl, phenyl, and cresyl glycidyl ethers reacted with (meth)acrylic acid, hydroxyl alkyl (meth) acrylates, such as hydroxyethyl and hydroxypropyl (meth) acrylates, amino (meth) acrylates, as well as (meth)acrylic acids such as (meth)acrylic acid, ethyl acrylic acid, alpha-chloroacrylic acid, alpha-cycanoacrylic acid, crotonic acid, beta-acryloxy propionic acid, and beta-styryl (meth)acrylic acid can be used as monomers. Any suitable combination of (meth)acrylic monomers such as the above may be utilised to prepare the (meth)acrylic polymer resins.

For the avoidance of doubt the term “structural unit” of any named monomer refers to the remnant of the monomer after polymerization. For example, a structural unit of methyl methacrylate is as illustrated:

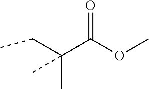

where the dotted lines represent the points of attachment of the structural unit to the polymer backbone.

The (meth)acrylic resin (a) (i) described herein may be prepared using an amount of acid monomers if desired. Acid monomers include carboxylic acid monomers such as, for example, acrylic acid, methacrylic acid, crotonic acid, itaconic acid, fumaric acid, maleic acid, monomethyl itaconate, monomethyl fumarate, monobutyl fumarate, and maleic anhydride; and sulfur- and phosphorous-containing acid monomers. When present preferred acid monomers are carboxylic acid monomers.

More preferred monomers are (meth)acrylic acid. The acid level can be calculated by determining the number of milliequivalents of acid per gram in the (meth)acrylic polymer and multiplying by the molecular weight of potassium hydroxide. When present, the (meth)acrylic resin may have an acid level in the range of from 0.25 to 5, for example from 0.25 to 3, or in the alternative from 0.5 to 2.5, or in the alternative from 1 to 2 wt. % (percent by weight) of acid monomers based on the total weight of the (meth)acrylic monomers.

The preferred method for preparing the (meth)acrylic resin (a) (i) is by emulsion polymerisation which may be initiated/catalysed by thermal, redox (using redox catalysts), photochemical, and electrochemical initiation, however, usually the polymerisation process is initiated/catalysed using one or more conventional free radical initiators such as, for example, peroxides, such as, for example, hydrogen peroxide, sodium or potassium hydroperoxide, t-alkyl peroxides, t-alkyl hydroperoxides e.g., dicumyl hydroperoxide t-amyl hydroperoxide t-butyl hydroperoxide; t-alkyl peresters, wherein the t-alkyl group includes at least 5 carbon atoms; perboric acids and their salts, such as, for example, sodium perborate; perphosphoric acids and salts thereof; ammonium and/or alkali persulfates, potassium permanganate; and ammonium or alkali metal salts of peroxydisulfuric acid. Such initiators may be used in amounts ranging from 0.01 to 3.0 wt. % (weight percent), based on the total weight of monomers. Redox systems using the same initiators coupled with a suitable reductant such as, for example, sodium sulfoxylate formaldehyde, sodium hydrosulfite, isoascorbic acid, hydroxylamine sulfate and sodium bisulfite may be used at similar levels, optionally in combination with metal ions such as, for example iron and copper, optionally further including complexing agents for the metal.

### Pre-Prepared Silicone Rubber Microparticles (a) (ii)

Binder (a) also comprises (a) (ii) pre-prepared silicone rubber microparticles in an amount of from 20 to 80 wt. %, alternatively from 40 to 80 wt. % based on the total wt. % of (a) (i)+ (a) (ii). The pre-prepared silicone rubber microparticles of the binder may be of any suitable type when present in the water-borne (meth)acrylic resin emulsion coating composition which is designed to be capable of forming a coating described herein. Preferably they have a mean particle size of from 0.5 to 10 μm, alternatively from 0.5 to 5 μm, alternatively from 0.5 to 3.5 μm, as determined by light scattering (LS) using a BI-90 particle size analyzer, Brookhaven Instruments Corp. (Holtsville, N.Y.).

If desired, the pre-prepared silicone rubber microparticles may be prepared in the form of a dispersion as utilised herein. In this situation, pre-prepared silicone rubber microparticles may be prepared as a reaction product of
(ai) a siloxane polymer having at least two-OH groups per molecule, or polymer mixture having at least two-OH groups per molecule, having a viscosity of between 5000 to 500,000 mPa·s at 23° C. and
(bi) at least one self-catalyzing crosslinker reactive with (ai), and
(ci) a surfactant and
(di) aqueous liquid continuous phase, typically water.

The siloxane polymers or polymer mixtures (ai) used as starting materials for the reaction product (i) above have a viscosity between 5,000 to 500,000 mPa·s, at 23° C. using a recording Brookfield viscometer with Spindle 3 at 2 rpm according to ASTM D4287-00 (2010). The siloxane polymers are described by the following molecular Formula (1)

X₃₋ₙRₙ—YO—(R¹₂SiO)_{z}—Y—RₙX₃₋ₙ (1)

where n is 0, 1, 2 or 3, z is an integer from 500 to 5000 inclusive, X is a hydrogen atom, a hydroxyl group and any condensable or any hydrolyzable group, Y is a Si atom or an Si—(CH₂)ₘ—SiR¹₂ group, R is individually selected from the group consisting of aliphatic, alkyl, aminoalkyl, polyaminoalkyl, epoxyalkyl, alkenyl or aromatic aryl groups and R¹ is individually selected from the group consisting of X (a hydrogen atom, a hydroxyl group and any condensable or any hydrolyzable group), aliphatic, alkyl, alkenyl and aromatic groups; and m is an integer between 1 and 12 inclusive, alternatively between 1 and 10 inclusive, alternatively between 1 and 6 inclusive.

The siloxane polymer (ai) can be a single siloxane represented by Formula (1) or it can be mixtures of siloxanes represented by the aforesaid formula or solvent/polymer mixtures. The term “polymer mixture” is meant to include any of these types of polymers or mixtures of polymers. As used herein, the term “silicone content” means the total amount of silicone in the dispersed phase of the dispersion, from whatever source, including, but not limited to the silicone polymer, polymer mixtures, self-catalytic crosslinkers (bi) and, if present in-situ resin reinforcers and stabilizers. Each X group may be the same or different and can be a hydrogen atom, hydroxyl group and any condensable or hydrolyzable group. The term “hydrolyzable group” means any group attached to the silicon which is hydrolyzed by water at room temperature. The hydrolyzable group X includes a hydrogen atom, halogen atoms, such as F, Cl, Br or I; groups of the Formula-OT, where T is any hydrocarbon or halogenated hydrocarbon group, such as methyl, ethyl, isopropyl, octadecyl, allyl, hexenyl, cyclohexyl, phenyl, benzyl, beta-phenylethyl; any hydrocarbon ether radical, such as 2-methoxyethyl, 2-ethoxyisopropyl, 2-butoxyisobutyl, p-methoxyphenyl or —(CH₂CH₂O)₂CH₃; or any N,N-amino radical, such as dimethylamino, diethylamino, ethylmethylamino, diphenylamino or dicyclohexylamino. X can also be any amino radical, such as NH₂, dimethylamino, diethylamino, methylphenylamino or dicyclohexylamino; any ketoxime radical of the formula —ON═CM₂ or —ON═CM′ in which M is any monovalent hydrocarbon or halogenated hydrocarbon radical, such as those shown for T above and M′ is any divalent hydrocarbon radical, both valences of which are attached to the carbon, such as hexylene, pentylene or octylene; ureido groups of the formula-N(M)CONM″₂ in which M is defined above and M″ is hydrogen atom or any of the above M radicals; carboxyl groups of the formula —OOCMM″ in which M and M″ are defined above or carboxylic amide radicals of the formula —NMC═O (M″) in which M and M″ are defined above. X can also be the sulphate group or sulphate ester groups of the formula —OSO₂(OM), where M is as defined above; the cyano group; the isocyanate group; and the phosphate group or phosphate ester groups of the formula —OPO(OM): in which M is defined above.

The most preferred X groups are hydroxyl groups or alkoxy groups. Illustrative alkoxy groups are methoxy, ethoxy, propoxy, butoxy, isobutoxy, pentoxy, hexoxy and 2-ethylhexoxy; dialkoxy radicals, such as methoxymethoxy or ethoxymethoxy and alkoxyaryloxy, such as ethoxyphenoxy. The most preferred alkoxy groups are methoxy or ethoxy.

R is individually selected from the group consisting of aliphatic, alkyl, aminoalkyl, polyaminoalkyl, epoxyalkyl, alkenyl organic and aromatic aryl groups. Most preferred are the methyl, ethyl, octyl, vinyl, allyl and phenyl groups.

R¹ is individually selected from the group consisting of X, aliphatic, alkyl, alkenyl and aromatic aryl groups. Most preferred are methyl, ethyl, octyl, trifluoropropyl, vinyl and phenyl groups.

When the siloxane polymer (ai) of formula (1) has an average of more than two condensable or hydrolyzable groups per molecule which are self-catalytic (or which may alternatively, perhaps be referred to as self-activating) it is not necessary to have the self-catalytic crosslinker present separately to form a crosslinked polymer. The condensable or hydrolyzable groups on the different siloxane molecules can react with each other to form the required crosslinks.

The siloxane polymer (ai) can be a mixture of different kinds of molecules, for example, long chain linear molecules and short chain linear or branched molecules. These molecules may react with each other to form a crosslinked network. Such siloxanes, which can take the place of more conventional crosslinkers, are illustrated by low molecular weight organosilicon hydrides, such as polymethylhydrogensiloxane, low molecular weight copolymers containing methylhydrogensiloxy and dimethylsiloxy groups, —(OSi(OEt)₂)—, (ethylpolysilicate), (OSiMeCH,Si(OMe)₃)₄ and (OSi—MeON═CR′₂)₄, where Me is methyl and Et is ethyl.

Advantageously, the siloxane polymer (ai) also comprises mixtures of siloxane polymers of formula (1), exemplified by, but not limited to, mixtures of α,ω-hydroxysiloxy terminated siloxanes and of α, ω-bis(triorganosiloxy) terminated siloxanes, mixtures of α,ω-hydroxylsiloxy terminated siloxanes and of α-hydroxy, ω-triorganosiloxy terminated siloxanes, mixtures of α,ω-dialkoxysiloxy terminated siloxanes and of α,ω-bis(tri-organosiloxy) terminated siloxanes, mixtures of α,ω-dialkoxysiloxy terminated siloxanes and of α, ω-hydroxysiloxy terminated siloxanes, mixtures of a, w-hydroxysiloxy terminated siloxanes and of α,ω-bis(triorganosiloxy) terminated poly(diorgano) (hydrogenorgano) siloxane copolymers. The siloxane polymer as hercinbefore described can also comprise mixtures of siloxane polymers of formula (1) as described above with liquid, branched methylpolysiloxane polymers (“MDT fluids”) comprising a combination of recurring units of the formulae: (CH₃)₃SiO₁₂ (“M”) (CH₃)₂SiO (“D”) CH₃SiO₃₂ (“T”) and containing from 0.1 to 8% hydroxyl groups. The fluids may be prepared by co-hydrolysis of the corresponding chloro- or alkoxy-silanes, as described, for example, in U.S. Pat. No. 3,382,205. The proportion of MDT fluids added should not exceed 50 parts, preferably of 1 to 20 parts by weight, per 100 parts by weight of the polymer of Formula (1), to achieve improved physical properties and adhesion of the resultant polymers. The siloxane polymer in the composition as hereinbefore described can also comprise mixtures of siloxane polymers of Formula (1) with liquid or solid, branched methylsiloxane polymeric resins comprising a combination of recurring units of the formulae:

(CH₃)₃SiO₁₂ (“M”)

(CH₃)₂SiO (“D”)

CH₃SiO₃₂ (“T”)

SiO₄₂(“Q”)

and containing from 0.1 to 8% hydroxyl groups, the fluids may be prepared by co-hydrolysis of the corresponding chloro- or alkoxy-silanes, as described, for example in U.S. Pat. No. 2,676,182. The MDTQ fluid/resin may be added in a proportion not exceeding 50 parts, preferably of 1 to 10 parts by weight, per 100 parts by weight of the polymer of Formula (1) to improve physical properties and adhesion of the resultant polymers. MDTQ fluids/resins can also be mixed with MDT fluids and the polymers of Formula (1).

The at least one self-catalytic crosslinker (bi) reactive with (ai) to form a reaction product of pre-prepared silicone rubber microparticles, is present in the amount of 1 to 5 parts by weight per 100 parts of siloxane polymer. The term “self-catalytic crosslinker” is well known and means a molecule that has at least one group serving as the catalytic species (or activating species). They are described for example in U.S. Pat. Nos. 5,939,478, 5,994,459 and 5,665,804. Hence, an alternative name for such a cross-linker might be a “self-activating cross-linker”, if preferred. For example, a molecule that has at least one functional group that reduces the energy activation level necessary for an e.g., hydroxyl functional groups on a siloxane polymer to condense forming a cross linked polymer. Such materials are used with a view to avoid the presence of residual catalyst in the pre-prepared silicone rubber microparticles.

While in certain circumstances only one self-catalytic crosslinker (bi) may be needed to produce an elastomer having the desired physical properties, those skilled in the art will recognize that two or more self-catalytic crosslinkers (bi) may be added to the reaction mixture to achieve excellent results. In addition, the self-catalytic crosslinker or crosslinkers (bi) may be added with a conventional catalyst. However, adding the self-catalytic crosslinker (bi) with a conventional catalyst is not required and the compositions contemplated herein may in fact be free of said conventional catalysts.

Typical self-catalytic crosslinkers (or alternatively self-activating cross-linkers) (bi) include tri or tetra functional compounds, such as R—Si-(Q)₃ or Si-(Q)₄, where Q is carboxylic, OC(O)R⁴, e.g., acetoxy and R⁴ is an alkyl group of 1 to 8 carbon atoms inclusive, preferably methyl, ethyl or vinyl. Other preferred Q groups are the hydroxyl amines, ON(R⁴)₂, where each R⁴ is the same or different alkyl group of 1 to 8 carbon atoms inclusive, e.g., ON(CH₂CH₃)₂. Q may also be an oxime group, such as O—N═C(R¹)₂, where each R¹ is the same or different alkyl group of 1 to 8 carbon atoms inclusive, e.g., O—N═C(CH₃) (CH₂CH₃). Further, Q may be an amine group, such as N(R⁵)₂, where R⁵ is the same or different alkyl group of 1 to 8 carbon atoms inclusive or cyclic alkyl group, e.g., N(CH₃)₂ or NH (cyclohexyl). Finally, Q may be an acetamido group, NRC(O)R⁴, where R⁴ is an alkyl group of 1 to 8 carbon atoms inclusive, e.g., N(CH₃)C(O)CH₃.

In addition, partial hydrolysis products of the aforementioned compounds may also function as self-catalytic crosslinkers (bi). This would include dimers, trimers, tetramers and the like, for example, compounds of the formula:

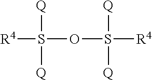

where Q and R¹ are defined in the preceding paragraph.

Also, useful as self-catalytic crosslinkers (bi) are those polymeric or copolymeric species containing 3 or more (Q) sites located at either pendant or terminal positions or both on the backbone of a polydiorganosiloxane molecule. Examples of the pendent group include compositions of the following formula:

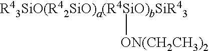

where R⁴ is as defined above and a is 0 or a positive integer and b is an integer greater than 2. In general, polymeric compositions having either pendent or terminal Q groups may be used, in particular, compounds of the formula:

Q₃₋ₙR⁶ₙSiO(R⁶₂SiO)_{z}SiR⁶ₙQ₃₋ₙ

where n is 0, 1, 2 or 3, z is a positive integer, R⁶ is Q or independently the same or different alkyl chain of 1 to 8 carbon atoms inclusive if there are at least three Q groups on the molecule. Q is as described above.

Effective self-catalytic crosslinkers (bi) (for which an alternative name may be self-activating cross-linkers) are those compounds which form tack free elastomers when mixed with functional silicone polymers in the absence of additional catalysts such as tin carboxylates or amines. In the self-catalytic crosslinkers, the acetoxy, oxime, hydroxyl amine (aminoxy), acetamide and amide groups catalyze/activate the formation of Si—O—Si bonds in the reactions contemplated.

One skilled in the art would recognize that the starting polymer itself could be pre-endblocked with self-catalytic crosslinking moieties. Optionally, further self-catalytic crosslinkers (bi) can be added to such compositions.

Those skilled in the art will recognize that these crosslinked, oil in water dispersions may be prepared in other ways. For instance, the siloxane polymer and self-catalytic crosslinker mixture may be added to a surfactant and water solution and then emulsified using colloid mills, homogenizers, sonolators or other high shear devices as described in U.S. Pat. Nos. 5,037,878 and 5,034,455. The dispersion may be formed by either a batch process, as described above, or a continuous process. If a continuous process is used, then a low shear dynamic mixer or static mixer is preferred.

The pre-prepared silicone rubber microparticles may be obtained by first mixing siloxane polymer (ai) and self-catalysing crosslinker (bi) and then introducing aqueous liquid continuous phase (di) usually in the form of water and surfactant (ci) to the preformed mixture of (ai) and (bi) and mixing (ai) to (di) together until a high solids gel phase is formed. Any type of mixing equipment may be used including low shear mixing equipment, such as Terrell™, Neulander™ or Ross™ mixers. The other ingredients of the composition may be introduced during the preparation of the pre-cured dispersion or alternatively may be added into the composition in any suitable order prior to use and after mixing, the resulting composition may be diluted with water to the desired silicone content. The pre-prepared silicone rubber microparticles reaction product is produced by mixing the above components at a sufficiently high shear to transform the mixture into a gel phase and by then diluting the gel with water to the desired silicone content.

### Aqueous Liquid Continuous Phase (b)

The water-borne (meth)acrylic resin emulsion coating composition also comprises an aqueous liquid continuous phase (b) in an amount of from 15 to 30 wt. %. The aqueous liquid continuous phase (b) is primarily water and may be solely water, but it may additionally contain small amounts of other solvents, such as alcohols and/or glycol ethers. The aqueous liquid continuous phase (b) evaporates during the drying/curing process of the paint/coating whilst the binder coalesces and forms a durable coating retaining the other ingredients of the coating composition. For the various embodiments, the aqueous coating composition as provided herein can have an aqueous liquid continuous phase (b) in an amount sufficient to provide an amount of from 15 to 30 wt. % alternatively 15 to 25 wt. %, of the water-borne (meth)acrylic resin emulsion coating composition.

When the water-borne (meth)acrylic resin emulsion coating composition is made by mixing the aforementioned aqueous (meth)acrylic resin emulsion with an aqueous dispersion of pre-prepared silicone rubber microparticles (a) (ii) as described above the aqueous liquid continuous phase (b) is the combined aqueous liquid continuous phase in the presence of the aqueous (meth)acrylic resin emulsion and the aqueous dispersion of pre-prepared silicone rubber microparticles (a) (ii). Additional water or the like may, if desired, be added during the preparation of the water-borne (meth)acrylic resin emulsion coating composition but this is not usually necessary.

### Surfactants (c)

The water-borne (meth)acrylic resin emulsion coating composition additionally comprises one or more surfactants (c) in an amount of from 0.5 to 5 wt. % alternatively from 0.5 to 3.0 wt. %, alternatively from 0.5 to 2.0 wt. % of the water-borne (meth)acrylic resin emulsion coating composition. Any suitable surfactants (c) may be utilised. These are used to stabilize the (meth)acrylic resin water-borne emulsions, aqueous dispersion of pre-prepared silicone rubber microparticles and water-borne (meth)acrylic resin emulsion coating composition described above. The surfactants (c) may be anionic, non-ionic, or amphoteric surfactant but may also comprise cationic surfactants, and mixtures thereof.

Anionic surfactants may include but are not limited to, alkali metal alkyl sulphates e.g., sodium Lauryl sulfate; Fatty Alcohol Ether Sulfates (FAES); Alkyl Phenol Ether Sulfates (APES); carboxylic, phosphoric and sulfonic acids and their salt derivatives; alkyl carboxylates; acyl lactylates; alkyl ether carboxylates; n-acyl sarcosinate; n-acyl glutamates; fatty acid-polypeptide condensates; alkali metal sulforicinates; sulfonated glycerol esters of fatty acids, such as sulfonated monoglycerides of coconut oil acids; salts of sulfonated monovalent alcohol esters, such as sodium oleylisethionate; amides of amino sulfonic acids, such as the sodium salt of oleyl methyl tauride; sulfonated products of fatty acids nitriles, such as palmitonitrile sulfonate; sulfonated aromatic hydrocarbons, such as sodium alpha-naphthalene monosulfonate; condensation products of naphthalene sulfonic acids with formaldehyde; sodium octahydroanthracene sulfonate; ether sulphates having alkyl groups of 8 or more carbon atoms; alkylarylsulfonates having 1 or more alkyl groups of 8 or more carbon atoms. Sodium dodecyl benzene sulfonate, dioctylsulfosuccinate, sodium polyoxyethylene lauryl ether sulfate, diphenylsulfonate derivatives, e.g., sodium dodecyl diphenyloxide disulfonate, sodium salt of tert-octylphenoxyethoxypoly (39) ethoxyethyl sulfate.

Anionic surfactants which are commercially available and useful herein may include but are not limited to, for the sake of example, POLYSTEP™ A4, A7, A11, A15, A15-30K, A16, A16-22, A18, A13, A17, B1, B3, B5, B11, B12, B19, B20, B22, B23, B24, B25, B27, B29, C-OP3S; ALPHA-STEP™ ML40, MC48; STEPANOL™ MG; all produced by STEPAN CO., Chicago, IL; HOSTAPUR IM SAS produced by HOECHST CELANESE; HAMPOSYL™ C30 and L30 produced by W.R.GRACE & CO., Lexington, MA.

Non-ionic surfactants include polyethoxylates, such as ethoxylated alkyl polyethylene glycol ethers; polyoxyalkylene alkyl ethers; polyoxyalkylene sorbitan esters; polyoxyalkylene esters; polyoxyalkylene alkylphenyl ethers, ethoxylated amides; ethoxylated alcohols; ethoxylated esters; polysorbate esters; polyoxypropylene compounds, such as propoxylated alcohols; cthoxylated/propoxylated block polymers and propoxylated esters; alkanolamides; amine oxides; fatty acid esters of polyhydric alcohols, such as ethylene glycol esters, diethylene glycol esters, propylene glycol esters, glyceryl esters, polyglyceryl fatty acid esters, sorbitan esters, sucrose esters and glucose esters. Commercial non-ionic surfactants include, for the sake of example, TERGITOL™ TMN-6, Tergitol™ TMN-10, TERGITOL™ 15S40, TERGITOL™ 15S9, TERGITOL™ 15S12, TERGITOL™ 15S15 and TERGITOL™15S20, and TRITON™ X405 produced by The Dow Chemical Company of Midland, Michigan; BRIJ™ 30 and BRIJ™ 35 produced by Croda (UK); MAKON™ 10 produced by STEPAN COMPANY, (Chicago, IL); and ETHOMID™ O/17 produced by Akzo Nobel Surfactants (Chicago, IL).

Amphoteric surfactants may include but are not limited to, glycinates, betaines, sultaines and alkyl aminopropionates. These include cocoamphglycinate, cocoamphocarboxy-glycinates, cocoamidopropylbetaine, lauryl betaine, cocoamidopropylhydroxysultaine, laurylsulataine and cocoamphodipropionate.

Amphoteric surfactants which are commercially available and useful herein may include but are not limited to, REWOTERICIM AM TEG, AM DLM-35, AM B14 LS, AM CAS and AM LP produced by SHEREX CHEMICAL CO., Dublin, OH.

Cationic surfactants may include but are not limited to, aliphatic fatty amines and their derivatives, such as dodecylamine acetate, octadecylamine acetate and acetates of the amines of tallow fatty acids;

homologues of aromatic amines having fatty chains, such as dodecylanalin; fatty amides derived from aliphatic diamines, such as undecylimidazoline; fatty amides derived from disubstituted amines, such as oleylaminodiethylamine; derivatives of ethylene diamine; quaternary ammonium compounds, such as tallow trimethyl ammonium chloride, dioctadecyldimethyl ammonium chloride, didodecyldimethyl ammonium chloride and dihexadecyldimethyl ammonium chloride; amide derivatives of amino alcohols, such as beta-hydroxyethylstearyl amide; amine salts of long chain fatty acids; quaternary ammonium bases derived from fatty amides of di-substituted diamines, such as oleylbenzylaminoethylene diethylamine hydrochloride; quaternary ammonium bases of the benzimidazolines, such as methylheptadecyl benzimidazole hydrobromide; basic compounds of pyridinium and its derivatives, such as cetylpyridinium chloride; sulfonium compounds, such as octadecylsulfonium methyl sulphate; quaternary ammonium compounds of betaine, such as betaine compounds of diethylamino acetic acid and octadecylchloromethyl ether;

urethanes of ethylene diamine, such as the condensation products of stearic acid and diethylene triamine; polyethylene diamines and polypropanolpolyethanol amines.

Cationic surfactants which are commercially available and useful herein may include but are not limited to, ARQUAD™ T27W, ARQUAD™ 16-29, ARQUAD™ C-33, ARQUAD™ T50, ETHOQUAD™ T/13 ACETATE, all manufactured by Akzo Nobel Surfactants (Chicago, IL). Anionic, non-ionic or amphoteric surfactants or their mixture are preferred in the case of the (meth)acrylic polymer emulsions. Some specific silicone surfactants which improve high temperature stability may also be utilised, such as branched or linear polyoxyalkylenes and specific fluorosurfactants.

The surfactants will usually be present at levels of 0.1 wt. % to 10 wt. %, alternatively, from 0.1% to 6 wt. %, based on the weight of total monomer during emulsion polymerisation.

When the water-borne (meth)acrylic resin emulsion coating composition is made by mixing the aforementioned aqueous (meth)acrylic resin emulsion with an aqueous dispersion of pre-prepared silicone rubber microparticles (a) (ii) as described above the surfactants (c) in the water-borne (meth)acrylic resin emulsion coating composition are the combined surfactants present in the aqueous (meth)acrylic resin emulsion and the aqueous dispersion of pre-prepared silicone rubber microparticles (a) (ii). Additional surfactants may, if desired, be added during the preparation of the water-borne (meth)acrylic resin emulsion coating composition but this is not usually necessary.

### Additional Ingredients (d)

The water-borne (meth)acrylic resin emulsion coating composition described abovealso comprises one or more additional ingredients (d). These may include one or more of the following for example, inorganic fillers, pigments and/or colorants including dyes, rheology modifiers, thickeners, defoamers, oxidants, reducing agents, chain transfer agents, neutralizers, dispersants, curing agents, buffers, corrosion inhibitors, neutralizers, humectants, fire retardants, wetting agents, UV absorbers, fluorescent brighteners, light or heat stabilizers, biocides, mildewcides, fungicides, algaecides, and combinations thereof, waxes, water-repellants, extenders, anti-oxidants, coalescing agents, preservatives and/or freeze/thaw additives.

A wide range of inorganic fillers may be utilised as additives in the water-borne (meth)acrylic resin emulsion coating composition. These include calcium carbonate (CaCO₃), quartz, untreated and treated silicas, colloidal silica, fumed silica, precipitated silica, metal hydroxide micropowders such as aluminum hydroxide micropowder, calcium hydroxide micropowder, and magnesium hydroxide micropowder, bisamides, mica, diatomaceous earth, ground quartz, kaolin, calcined kaolin, wollastonite, hydroxyapatite, hydrated alumina, magnesium hydroxide, carbon black, titanium dioxide, aluminium oxide, vermiculite, zinc oxide, talcum, iron oxide, barium sulphate and slaked lime or a mixture thereof.

Typically, the filler(s), when present are present in an amount of from 2 to 20 wt. % of the water-borne (meth)acrylic resin emulsion coating composition. Hydrophobing agents may be provided to treat the aforementioned filler(s) to render them hydrophobic if desired. The hydrophobing agents may be for example silanes, e.g., alkoxy silanes, silazanes and or short chain (2-20) organopolysiloxanes or alternatively stearates or the like.

Any suitable pigments and/or colorants may be added if desired, particularly in the case of paints and for coloured coatings. The pigments and/or colorants may coloured, white, black, metal effect, and luminescent e.g., fluorescent and phosphorescent.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g., phthalocyanine blue and phthalocyanine green; monoarylide yellow, diarylide yellow, benzimidazolone yellow, heterocyclic yellow, DAN orange, quinacridone pigments, e.g., quinacridone magenta and quinacridone violet; organic reds, including metallized azo reds and nonmetallized azo reds and other azo pigments, monoazo pigments, diazo pigments, azo pigment lakes, B-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

The water-borne (meth)acrylic resin emulsion coating composition may comprise one or more rheology modifiers and/or thickeners. Whilst these may include one or more naturally occurring polymers having e.g., polysaccharide or amino acid building blocks, such as starch, modified starch, proteins, and modified proteins, dimeric and trimeric fatty acids and/or imidazolines, they preferably comprise one or more synthetic acrylic-based polymers selected from alkali-swellable (or soluble) emulsions (ASE's) or associative thickeners (water-soluble polymer containing several relatively hydrophobic groups) such as hydrophobically modified alkali-swellable emulsions (HASE's) and hydrophobically modified, ethoxylated urethane resins (HEUR's) and/or other rheology modifiers/thickeners such as hydroxyethyl celluloses (HECs) and suitable styrene-maleic anhydride terpolymers (SMATs).

ASE-thickeners are similar in polymer structure to HASE thickeners but do not contain the hydrophobe groupings, i.e., they are dispersions of insoluble acrylic polymers in water which have a high percentage of acid groups distributed throughout their polymer chains. When the acid groups are neutralized, the salt that is formed is ‘hydrated’ the salt either swells in aqueous solutions or becomes completely water soluble. As the concentration of neutralized polymer in an aqueous formulation increases, the swollen polymer chains start to overlap, until they ‘tangle up’. It is this overlapping and tangling that causes viscosity to increase. Again, the concentration of acid groups, the molecular weight and degree of crosslinking of the polymer are important in determining rheology and thickening efficiency. Examples include ACRYSOL™ ASE-75 from Dow. HASE polymers are commercially important as associative thickener type rheology modifiers in aqueous paints and coatings. They are dispersions of water-insoluble acrylic polymers in water which may be rendered water soluble by neutralizing acid groups on the polymer chain and also contain long-chain hydrophobic groups, sometimes referred to as “hydrophobes”. Typically, they are aqueous dispersion of copolymers of
(i) acylate ester or methacrylate ester monomers such as methyl methacrylate ethyl acrylate, butyl acrylate, or ethylhexyl acrylate);
(ii) methacrylic acid, acrylic acid, or itaconic acid; and
(iii) monomers containing long chain hydrophobic groups such as an ethylenically unsaturated polyethylene oxide (polyEO) macromonomer, e.g., an alkylated ethoxylate monomer, preferably an alkylated ethoxylate acrylate or methacrylate.

The alkylated chains may be in the range of C10 to C25, alternatively C12 to C20.

For example, the following commercially available HASEs from the Dow Chemical Company contain polymerized units of ethyl acrylate and methacrylic acid monomers with hydrophobes attached, ACRYSOL™ DR-6600, ACRYSOL™ DR-5500, ACRYSOL™ RM-7 ACRYSOL™ TT-615, ACRYSOL™ DR-72 and ACRYSOL™ TT-935. Other commercially available HASEs include ACRYSOL™ Primal HT-400, ACULYN™ 88, ACULYN™28, ACULYNL™ 88 and Romax™ 7011 from the Dow Chemical Company, and RHEOTECH™ 4800 from Coatex.

Hydrophobe modified ethoxylated urethanes (HEURs) associative thickener type rheology modifiers are widely used in water-borne coatings for their desirable rheological and application properties for example ACRYSOL™ RM-725 and ACRYSOL™ 2020 NPR are commercially available from the Dow Chemical Company. The hydrophobically modified alkylene oxide urethane polymer is a polyethylene oxide, polypropylene oxide, or polybutylene oxide urethane polymer, preferably a polyethylene oxide urethane polymer modified with suitable the hydrophobes and may be prepared by e.g., reacting a diisocyanate; a water soluble polyalkylene glycol; and a capping agent comprising the hydrophobe. The hydrophobes are then introduced by end-capping this isocyanate terminated prepolymer with e.g., hydrophobic alcohols or amines.

Hydroxyethyl cellulose polymers (HEC) are non-ionic, water-soluble polymer that can thicken, suspend, bind, emulsify, form films, stabilize, disperse, retain water, and provide protective colloid action. They are readily soluble in hot or cold water and can be used to prepare solutions with a wide range of viscosities. Examples include Natrosol™ 250 HBR (a water-soluble, non-ionic hydroxyethyl cellulose surface-treated with glyoxal from Ashland Specialty Chemical).

The rheology modifiers/thickeners may be present in an amount of from 0.2 to 5.00 weight % of the emulsion alternatively in an amount of from 0.5 to 3.5 wt. % of the water-borne (meth)acrylic resin emulsion coating composition.

When the water-borne (meth)acrylic resin emulsion coating composition is made by mixing the aforementioned aqueous (meth)acrylic resin emulsion with an aqueous dispersion of pre-prepared silicone rubber microparticles (a) (ii) as described above the additional additives (d) in the water-borne (meth)acrylic resin emulsion coating composition are the combined additional additives present in the aqueous (meth)acrylic resin emulsion and the aqueous dispersion of pre-prepared silicone rubber microparticles (a) (ii). More additional additives (d) may, if desired, be added during the preparation of the water-borne (meth)acrylic resin emulsion coating composition but this is not usually necessary.

Typically, the total wt. % of the water-borne (meth)acrylic resin emulsion coating composition described herein is 100 wt. % and the total wt. % of additional additives (d) present is the difference between 100 wt. % and the cumulative wt. % of components (a), (b) and (c) of the water-borne (meth)acrylic resin emulsion coating composition. When the water-borne (meth)acrylic resin emulsion coating composition is made by mixing the aforementioned aqueous (meth)acrylic resin emulsion with an aqueous dispersion of pre-prepared silicone rubber microparticles (a) (ii) as described above, the selected additional additives may be present in either or both the aqueous (meth)acrylic resin emulsion and the aqueous dispersion of pre-prepared silicone rubber microparticles (a) (ii), alternatively additives (d) may be introduced into the water-borne (meth)acrylic resin emulsion coating composition after the aqueous (meth)acrylic resin emulsion and the aqueous dispersion of pre-prepared silicone rubber microparticles (a) (ii) have been inter-mixed.

Hence, the water-borne (meth)acrylic resin emulsion coating composition described herein comprises any suitable combination of
a binder (a) in an amount of from 30 to 70 wt. % of the water-borne (meth)acrylic resin emulsion coating composition, alternatively 40 to 60 wt. % of the water-borne (meth)acrylic resin emulsion coating composition comprising
   (a) (i) a (meth)acrylic resin in an amount of from 20 to 80 wt. % and
   (a) (ii) pre-prepared silicone rubber microparticles in an amount of from 20 to 80 wt. %; based on the total wt. % of (a) (i)+ (a) (ii); alternatively, binder (a) comprises
(a) (i) a (meth)acrylic resin in an amount of from 20 to 60 wt. % and
(a) (ii) prc-prepared silicone rubber microparticles in an amount of from 40 to 80 wt. %; based on the total wt. % of (a) (i)+ (a) (ii).
(b) an aqueous liquid continuous phase in an amount of from 15 to 30 wt. %, alternatively 15 to 25 wt. %, of the water-borne (meth)acrylic resin emulsion coating composition;
(c) one or more surfactants in an amount of from 0.5 to 5 wt. %, alternatively from 0.5 to 3.0 wt. %, alternatively from 0.5 to 2.0 wt. % of the water-bome (meth)acrylic resin emulsion coating composition; and
(d) one or more additives in an amount of the difference between 100 wt. % and the cumulative wt. % of (a)+ (b)+ (c).

The total weight (wt.) % of the water-borne (meth)acrylic resin emulsion coating composition described above is 100 wt. %. Furthermore, such a composition is designed to be capable of forming a continuous coating on a suitable substrate once applied thereon and allowed to dry. In one embodiment there is a method of making a water-borne (meth)acrylic resin emulsion coating composition as hereinbefore described by mixing an aqueous (meth)acrylic resin emulsion comprising
a (meth)acrylic resin (a) (i), and
a suitable surfactant
in an aqueous liquid continuous phase with
an aqueous dispersion of pre-prepared silicone rubber microparticles (a) (ii) comprising said pre-prepared silicone rubber microparticles (a) (ii) in the presence of one of more suitable surfactants in an aqueous liquid continuous phase;
wherein one or more additives are added into either the aqueous (meth)acrylic resin emulsion, the aqueous dispersion of pre-prepared silicone rubber microparticles (a) (ii) or both prior to mixing and/or are added to the water-borne (meth)acrylic resin emulsion coating composition after said aqueous (meth)acrylic resin emulsion and said aqueous dispersion of pre-prepared silicone rubber microparticles (a) (ii) have been mixed together.

The (meth)acrylic resin (a) (i) may be prepared by any suitable process but is preferably prepared by emulsion polymerisation resulting in the (meth)acrylic resin emulsion described above. Likewise, the silicone rubber microparticles (a) (ii) are prepared as described above i.e., in the form of an aqueous dispersion of pre-prepared silicone rubber microparticles (a) (ii).

Hence, the method of making a water-borne (meth)acrylic resin emulsion coating composition as described above may comprise the following steps:
(I) preparing a (meth)acrylic resin water-borne emulsion by emulsion polymerization of a (meth) acrylate monomer selected from the group comprising an acrylic ester, a methacrylic ester or a mixture thereof in an aqueous liquid continuous phase (b) in the presence of a suitable surfactant (c);
(II) preparing an aqueous dispersion of pre-prepared silicone rubber microparticles
(a) (ii) in an aqueous liquid continuous phase (b) by stirring the pre-prepared silicone rubber microparticles (a) (ii) in the aqueous liquid continuous phase in the presence of one of more suitable surfactants (c),
(III) Mixing the resulting products of steps (II) and (IV) in a predefined ratio to form a final water-borne (meth)acrylic resin emulsion coating composition and
(IV) Introducing one or more additives into either the aqueous (meth)acrylic resin emulsion, the aqueous dispersion of pre-prepared silicone rubber microparticles (a) (ii) or both prior to mixing and/or are added to water-borne (meth)acrylic resin emulsion coating composition after said aqueous (meth)acrylic resin emulsion and said aqueous dispersion of pre-prepared silicone rubber microparticles (a) (ii) have been mixed together.

In step (I) a (meth)acrylic resin water-borne emulsion is prepared by emulsion polymerization. This can be achieved using the emulsion polymerisation process previously described. The surfactants (c) are present to emulsify the reactants during emulsion polymerisation. Additional surfactant (c) may be added after the completion of the emulsion polymerisation if desired. The additional surfactant may be the same or different to that utilised during the emulsion polymerisation.

One or more additional additives may be introduced into the (meth)acrylic emulsion before, during or after step (I) described above. For example, the additional additive(s) may be one or more defoamers which are interchangeably referred to as antifoaming agents (hereafter referred to as “defoamer(s)”. Any suitable defoamer may be utilised such as a silicone polyether defoamer. A commercial example of a suitable defoamer is DOWSIL™ 8590 from Dow Silicones Corporation. As indicated above the defoamer(s) may be introduced into the (meth)acrylic emulsion before during or after step (I) described above. Upon completion of the emulsion polymerisation, the resulting (meth)acrylic resin water-borne emulsion preferably has the physical characteristics mentioned above.

It was found that the inclusion of a significant amount of pre-prepared silicone rubber microparticles in a (meth) acrylate binder (e.g., much more than the previous limit of about 10 wt. %) was possible by introducing the pre-prepared silicone rubber microparticles into an aqueous (meth) acrylate emulsion after its preparation in the form of an aqueous dispersion of pre-prepared silicone rubber microparticles. Whilst this may be undertaken via any method it was found the best method was to make an aqueous dispersion of the pre-prepared silicone rubber microparticles via steps (II) above and then by introducing the aqueous dispersion of the pre-prepared silicone rubber microparticles into the aqueous (meth) acrylate emulsion after its preparation in a step (III) to form a final water-borne (meth)acrylic resin emulsion coating composition as defined above.

The aqueous dispersion of the pre-prepared silicone rubber microparticles can be prepared as a rcaction product of
(ai) a siloxane polymer having at least two-OH groups per molecule, or polymer mixture having at least two-OH groups per molecule, having a viscosity of between 5000 to 500,000 mPa·s at 23° C.,
(bi) at least one self-catalyzing crosslinker reactive with (ai), in the presence of
(ci) a surfactant and
(di) an aqueous continuous phase (which may be water.

The dispersion of pre-prepared silicone rubber microparticles may be obtained by first mixing siloxane polymer (ai) and the self-catalysing crosslinker (bi) and then introducing water (di) and surfactant (ci) to the preformed mixture of (ai) and (bi) and mixing (ai) to (di) together until a high solids gel phase is formed. Any type of mixing equipment may be used including low shear mixing equipment, such as Terrell™, Neulander™ or Ross™ mixers.

The dispersion of pre-prepared silicone rubber microparticles may be produced by mixing the above components at a sufficiently high shear to transform the mixture into a gel phase and by then diluting the gel with water to the desired silicone content.

The dispersion of pre-prepared silicone rubber microparticles resulting from step (II) above may be of any suitable concentration providing the required concentration of pre-prepared silicone rubber microparticles is attained in the final water-borne (meth)acrylic resin emulsion coating composition.

The dispersion of pre-prepared silicone rubber microparticles resulting from step (II) above are provided in a composition additionally comprising (c) a surfactant and (d) water. The surfactant (c) may be solely (ci) and may be selected from any of the non-ionic surfactants, cationic surfactants, anionic surfactants, amphoteric surfactants or mixtures thereof described above. Most preferred are non-ionic surfactants known in the art as being useful in emulsification of polysiloxanes, however suitable cationic and anionic surfactants are also useful as the surfactant for the dispersion. Specific silicone surfactants which improve high temperature stability may also be utilised, such as branched or linear polyoxyalkylenes and specific fluorosurfactants may be utilised in as the surfactant for the dispersion.

Step (IV) of the process described above indicates the addition of additives. Such additives may be, for example, inorganic fillers, pigments and/or colorants including dyes, rheology modifiers, thickeners, defoamers, oxidants, reducing agents, chain transfer agents, neutralizers, dispersants, curing agents, buffers, corrosion inhibitors, neutralizers, humectants, fire retardants, wetting agents, UV absorbers, fluorescent brighteners, light or heat stabilizers, biocides, mildewcides, fungicides, algaecides, and combinations thereof, waxes, water-repellants, extenders, anti-oxidants, coalescing agents, preservatives and/or freeze/thaw additives. It does not matter which additives are introduced into the emulsion and which into the dispersion or indeed after they have been mixed together e.g., in step (III) i.e., they may be the same or different, however they must be compatible, if present, when being mixed together e.g., when undertaking step (III) of the process mentioned above, such that all the ingredients are compatible in the final water-borne (meth)acrylic resin emulsion coating composition.

Specific examples of additional additives which may be used in the pre-prepared silicone rubber microparticle composition include fillers, such as certain types of silicas, or calcium carbonate; suitable stabilizers for example a pH stabilizer or any of the aminosilane containing polymeric or neat aminosilanes described above will function as a stabilizer.

It is important that the ingredients in the aqueous pre-prepared silicone rubber microparticles dispersion component are compatible when mixed and as such should be selected accordingly. Likewise, it is important that the ingredients in the (meth)acrylic emulsion component are compatible when mixed and as such should be selected accordingly. After the aqueous pre-prepared silicone rubber microparticles dispersion component and the (meth)acrylic emulsion component have been individually prepared as described above the aqueous dispersion component containing pre-prepared silicone rubber microparticles component and (meth)acrylic emulsion component are blended together via any suitable means in step (III), for example, mixers such static mixers, also known as in-line mixers, or an agitated tank to form the aqueous based blend composition.

Without being bound by a specific theory, it is believed that the coating formed after applying the water-borne (meth)acrylic resin emulsion coating composition described herein on to a required substrate, in such a manner that predominantly the constituents of the binder particles from the aqueous pre-prepared silicone rubber microparticles dispersion component and (meth)acrylic emulsion component coalesce (fuse) to form a continuous film with the pre-prepared silicone rubber microparticles homogeneously and evenly blended throughout the continuous film.

The high loading (i.e., much greater than 10 wt. %) of pre-prepared silicone rubber microparticles into the water-borne (meth)acrylic resin emulsion coating composition described herein is not practically possible if added into the emulsion polymerisation of the resin prior to or during polymerisation as instead of generating single independent particles, the course of polymerization might lead to undesirable crosslinking and poor polymerization kinetics. These polymerization difficulties lead the (meth)acrylic component to gelation, high molecular weight distributions, lower than anticipated average molecular weight hindering the ability to form a good continuous film and therefore the performance of the coating. By preparing the pre-prepared silicone rubber microparticles dispersed in water and the (meth)acrylic emulsion, separately we can achieve the desired composition and performance balance when blended together.

The pre-prepared silicone rubber microparticles provide the advantage of maintaining mechanical integrity to the coating while improving water resistance, water vapor permeation, and chalking resistance in comparison to the (meth)acrylic control coating. When compared to the silicone water-borne coatings, the coating has better tint (color) retention, dirt pickup resistance and shelf-life. The resulting water-borne (meth)acrylic resin emulsion coating composition described herein may be applied onto a suitable substrate by any suitable method. For example, the water-borne (meth)acrylic resin emulsion coating composition may be spray-applied, brushed, rolled, trowelled or otherwise coated onto a substrate although spraying techniques are preferred. Once applied as a coating on the substrate the composition will form an elastomeric film upon the evaporation of water although it is to be noted that no cure reaction takes place upon application to a substrate the coating merely dries on the substrate surface, typically through water evaporation. The step of evaporation of water may be performed under ambient, or atmospheric conditions at the location of the substrate when the cross-linked polysiloxane dispersion composition is applied. Alternatively, the step of evaporation of water may be performed under artificially heated conditions, produced by one or more heaters.

This pre-crosslinked silicone particles are thought to function as an entrapped solid filler or/extender in the coalesced filmic coating once the water has evaporated. But their presence improves water vapor permeation and water resistance of the film as compared to films containing 100% (meth)acrylic binders. Additionally, when compared to commercially available waterborne silicones coatings, the technology shows improved shelf-life and better film formation leading to better dirt pickup resistance and color retention (alternatively referred to as tint retention).

The water-borne (meth)acrylic resin emulsion coating composition comprising a much greater amount of silicone rubber microparticles than previously thought possible have tremendous versatility with benefits across a wide variety of applications such as for building and construction applications, in paints and coatings applications, for personal care applications, in films, tapes and release liner applications and for textiles, leather and nonwoven material applications.

In the case of Building and construction compositions as hereinbefore described containing much greater levels of the pre-prepared silicone rubber microparticles in the binder can improve sustainability, durability and aesthetics of building materials and improve moisture, corrosion, temperature extremes and weathering resistance of architectural coatings. In the case of paints and coatings the composition may be used to provide adhesion over a variety of substrates, superior film resistance properties, flexibility, durability, and enhances hiding while enabling low VOC and sustainable solutions necessary for today. In the case of personal care applications, the use of the composition herein can improve wash-off resistance, water repellency, durability and other performance attributes in sun, skin and hair care products; colour cosmetics; and deodorants/antiperspirants. In the case of films, tapes and release liner applications, such coatings, dependent on the additives introduced, may be used in or as pressure-sensitive adhesives and release coatings that provide exceptional performance over a range of application requirements. Finally, in the case of textiles, leather and nonwoven material applications, compositions herein may be used in printing, coating and back coating of textiles, as coatings for bonding nonwoven webs, topcoat additives and fabric coatings. Specific examples include as a paint, an undercoating or finish coating material for building materials, an adhesive, a pressure-sensitive adhesive, a processing agent for papers, or a finish coating material for textile fabrics, especially as a paint, or a finish coating material for building materials.

### EXAMPLES

In the following examples all viscosity measurements were taken at room temperature (approximately 23° C.) using a Brookfield™ Synchro-lectric Model HAF Serial #72468, Spindle 3, at 2 rpm.

A series of compositions were prepared as examples using the standard formulation depicted in Table 1a. The different examples and comparatives utilised contained different blends of pre-prepared silicone rubber microparticles and (meth)acrylic resin binders as explained below and depicted in Tables 1b and 1c. In the comparative compositions the binder was either 100 wt. % (meth)acrylic resin (a) (i) or 100 wt. % pre-prepared silicone rubber microparticles (a) (ii); based on the total wt. % of (a) (i)+ (a) (ii). In the examples in support of this disclosure the binder was a combination of (meth)acrylic resin (a) (i) and pre-prepared silicone rubber microparticles (a) (ii); based on the total wt. % of (a) (i)+ (a) (ii) as specified in Tables 1b and 1c. For the examples involving mixtures of (meth)acrylic resin (a) (i) and pre-prepared silicone rubber microparticles (a) (ii), such compositions were prepared by mixing an aqueous (meth)acrylic resin emulsion comprising the (mcth) acrylic resin (a) (i), surfactant and additive(s) in an aqueous liquid continuous phase with an aqueous dispersion of pre-prepared silicone rubber microparticles (a) (ii) in the presence of one of more suitable surfactants and additive(s) in an aqueous liquid continuous phase.

TABLE 1a
composition used in the Examples and comparatives

| Ingredients | Loading (wt. %) |
|---|---|
| Binder (total wt. % of (meth)acrylic | 53 |
| resin (a)(i) + pre-prepared | |
| silicone rubber microparticles (a)(ii) | |
| CaCO₃ filler | 10 |
| TiO₂ pigment | 10 |
| Surfactant | 1 |
| Rheology modifier Package | 2.3 |
| Water | 21.7 |
| Propylene Glycol | 1 |
| Defoamer | 1 |

### Ingredients in the Examples and Comparative Examples,

The silicone rubber microparticles utilised are commercially available as DOWSIL™ 8004 Waterborne Resin and have a mean particle size of about lum when tested using the Dow Silicones Corporation Corporate Test Method 0201 which is available from the company upon request.
(Meth) Acrylic resin 1 was provided in a (meth)acrylic Resin binder commercially available as RHOPLEX™ EI-2000 which has a Tg of 5° C.;
(Meth) Acrylic resin 2 was provided in a (meth)acrylic Resin binder commercially available as RHOPLEX™ 78 which has a Tg of −18° C.;
(Meth) Acrylic resin 3 was provided in a (meth)acrylic Resin binder commercially available as RHOPLEX™ EC-1741 which has a Tg=−30° C.
(Glass transition temperature (Tg) measurements: the samples were weighed into Tzero aluminum pans (˜10 mg of sample) and analyzed on a TA Instrument Q2000 DSC using Thermal Advantage/Universal Analysis, software version 4.7A.).
RHOPLEX™ EI-2000, RHOPLEX™ 78 and RHOPLEX™ EC-1741 are all commercially available from the Dow Chemical Company of Midland Michigan USA.

The calcium carbonate filler used was OMYACARB™ UF which is commercially available from Omya;

The surfactant used was Tergitol™ TMN-10, and the defoamer was DOWSIL™ 8590 Additive, both of which are commercially available from Dow Chemical; and

The rheology modifier was a mixture of hydroxyethyl cellulose (NATROSOL™ Cellulose Ethers, ASHLAND, Inc.), ACRYSOL™ RM-725 and ACRYSOL™ 2020 NPR.

Table 1b has been adjusted to identify the relative amounts of (meth)acrylic resin (a) (i) and pre-prepared silicone rubber microparticles in the (meth)acrylic Resin binder and pre-formed silicone rubber microparticle dispersion respectively (before being mixed together) The non-volatile content of the (meth)acrylic binder and pre-prepared silicone rubber microparticles was determined by using ASTM D2369-20 Standard Test Method to initially determine the volatile content of compositions. For example, if a 50/50 actives blend by weight, between pre-prepared silicone rubber microparticles and (meth)acrylic binder was targeted (100 g total formulation) 33 grams of (meth)acrylic binder at 50% solids were mixed with 20 grams of pre-prepared silicone rubber microparticles at 85% solids to yield a mixture containing 17 g active (meth)acrylic binder and 17 g of active pre-prepared silicone rubber microparticles. To adjust the ratios as described in Table 1b, a similar protocol was followed.

TABLE 1b
Relative amounts (wt. %) of (meth)acrylic resin (a)(i) and pre-prepared silicone
rubber microparticles (a)(ii) based on the total wt. % of (a)(i) + (a)(ii)
in the identified water-borne (meth)acrylic resin emulsion coating composition

| | C. 1 | C. 2 | C. 3 | Ex. 1 | Ex. 2 | Ex. 3 | Ex. 4 | Ex.5 | Ex. 6 |
|---|---|---|---|---|---|---|---|---|---|
| silicone rubber | 100 | | | 50 | 75 | 50 | 30 | — | 50 |
| microparticles | | | | | | | | | |
| (1 μm) | | | | | | | | | |
| silicone rubber | | | | | | | | 30 | — |
| microparticles | | | | | | | | | |
| (3 μm) | | | | | | | | | |
| (Meth)Acrylic | | 100 | — | 50 | 25 | — | | — | — |
| resin 1 | | | | | | | | | |
| (Meth)Acrylic | | — | 100 | — | — | 50 | 70 | 70 | — |
| resin 2 | | | | | | | | | |
| (Meth)Acrylic | | — | — | — | — | — | | — | 50 |
| resin 3 | | | | | | | | | |

TABLE 1c
individual wt. % of silicone rubber microparticles & (Meth)Acrylic
resin present in the compositions depicted in Table 1a based
on the combined amount being 53 wt. % of the composition.

| | C. 1 | C. 2 | C. 3 | Ex. 1 | Ex. 2 | Ex. 3 | Ex. 4 | Ex. 5 | Ex. 6 |
|---|---|---|---|---|---|---|---|---|---|
| silicone rubber | 53 | | | 26.5 | 39.75 | 26.5 | 14.5 | — | 26.5 |
| microparticles | | | | | | | | | |
| (1 μm) | | | | | | | | | |
| silicone rubber | | | | | | | | 14.2 | — |
| microparticles | | | | | | | | | |
| (3 μm) | | | | | | | | | |
| (Meth)Acrylic | | 53 | — | 26.5 | 10.25 | — | | — | — |
| resin 1 | | | | | | | | | |
| (Meth)Acrylic | | — | 53 | — | — | 26.5 | 37.7 | 31.0 | — |
| resin 2 | | | | | | | | | |
| (Meth)Acrylic | | — | — | — | — | — | | — | 26.5 |
| resin 3 | | | | | | | | | |

In Table 1c it can be clearly seen that the amount of silicone rubber microparticles present in each composition is significantly greater than 10 wt. % which previously appeared to be the functional limit when the silicone rubber microparticles were introduced into the monomer before commencement of the emulsion polymerisation of the (Meth) Acrylic resin or during the emulsion polymerisation of the (Meth) Acrylic resin.

### Sample Testing

A variety of tests were undertaken to test the properties and suitability of the compositions of various examples and comparative examples identified in Tables 1a. 1b and 1c.

### Accelerated QUV Testing

Water-borne (meth)acrylic resin emulsion coating compositions prepared in accordance with Tables 1a 1b and 1c were prepared and were, where required, aged in a QUV weathering chamber (model SE). The following cycles were used:
cycle 1:8 hours of UV (UVA 340 nm) exposure at 60° C.,
cycle 2:4 hours of condensation at 50° C.

These cycles were repeated until desired length of time was reached at which point samples were removed from the QUV and allowed to rest at room temperature overnight to equilibrate before being tested.

Shelf-life, dirt pick-up resistance, adhesion to concrete and paintability were assessed as follows and the results are provided in Tables 2a and 2b below.

### Shelf-Life

The heat aged stability of coating composition was tested by determining the change in viscosity after aging samples at 50° C. for a week. Samples of fully formulated coating compositions had their initial viscosity measured using Brookfield™ Synchro-lectric Model HAF Serial #72468, Spindle 3, at 2 rpm at room temperature and were then aged at 50° C. in a suitable oven with their viscosity measured (at room temperature) weekly using the Brookfield™ Synchro-lectric Model HAF Serial #72468, Spindle 3, at 2 rpm. For example, the weekly viscosity results for Ex. 1, Ex. 2 and C. 1 are provided in Table 2a.

Given it is standard practice to assume that each week of aging at 50° C. corresponds to ˜2 months aging at room temperature, an estimation of the accelerated Shelf-Life was determined for examples and comparatives and these are depicted in Table 2b.

### Dirt Pick-Up Resistance

Dirt pick-up is a long-standing issue for exterior architectural coatings. Improvements therefore in dirt pick-up resistance (DPR) are highly sought after by end users. Drawdowns (25 mm/10 mils) were made over bare aluminium and allowed to dry for 7 days prior exterior exposure. The panels were placed at a South Orientation angled at 45° in Dow Chemical Paint Farm Exposure Farm located in Spring House, PA, USA. Results with respect to DPR were determined using ASTM D 3719-00 after 24 months of exterior exposure. L* the arithmetic mean was measured for all samples prior exposure and after 24 months of exposure. In the arithmetic L* measurement includes any biofilm growth that occurred curing exposure. Samples were not washed before measurements.

### Adhesion to Concrete

Adhesion to concrete of samples described herein were assessed based on ASTM 4541. Testing was undertaken after 1000 hours of QUV aging. All samples were drawdown to 10 mils (0.25 mm) over precast concrete and allowed to dry for 7 days at 22° C. prior testing.

### Paintability

The paintability of the hybrid coating was assessed in accordance ASTM D3359: Standard Test Method for Rating Adhesion by Tape Test. Samples were drawdown to a thickness of 10 mils (0.25 mm) and allowed to dry at 22° C. for seven days prior testing. A rating of 5B correspond to 0% removal by the tape after cross hash cut. A rating of OB corresponds to 100% removal by the tape after the cross hash cut.

TABLE 2a
Extended shelf-life - Heat Aged Viscosity (mPa ·
s) at room temperature Synchro-lectric Model HAF Serial
#72468, using Spindle 3, 2 revolutions per minute
(rpm), using Spindle 3, 2 revolutions per minute (rpm)

| Week | C. 1 | Ex. 1 | Ex. 2 |
|---|---|---|---|
| 0 | 32000 | 46000 | 42000 |
| 1 | 29500 | 49500 | 49000 |
| 2 | 47500 | 50500 | 495000 |
| 3 | 100000 | 51500 | 51000 |
| 4 | x | 52000 | 49000 |
| 5 | x | 52000 | 47500 |
| 6 | x | 52000 | 47500 |
| 7 | x | 52000 | 46500 |
| 8 | x | 51500 | 46500 |
| 9 | x | 51000 | 44500 |
| 10 | x | 51000 | 45000 |

TABLE 2b
Shelf-life, dirt pick-up resistance, adhesion
to concrete and paintability Assessment

| | C. 1 | Ex. 3 | Ex. 5 | C. 3 |
|---|---|---|---|---|
| Shelf Life (Months) | ≤12 | ≥20 | ≥20 | ≥15 |
| Dirt Pick Up Resistance (ASTM | 86.6 | 88.3 | 96.7 | 93.9 |
| 3719 - Dirt Pickup Index, %. | | | | |
| Exterior Exposure Spring | | | | |
| House, PA. 24 months) | | | | |
| Adhesion to concrete - after | P | P | P | ND |
| 1000 QUV Hrs. | | | | |
| Paintability by (meth)acrylic | 0B | 5B | 5B | ND |
| coatings (Rating) | | | | |

P = passed & ND = No Data

Tables 2a and 2b provide a summary of key property improvements of the disclosure herein relative to comparative example 1 where the coating composition comprises solely pre-prepared silicone rubber microparticles in the binder and comparative examples 2 and 3 comprising (meth)acrylic resin and no pre-prepared silicone rubber microparticles in the binder. The water-borne (meth)acrylic resin emulsion coating compositions showed improved coating performances as described herein such as shelf-life and adhesion profile by other chemistries (acrylics and polyurethanes) are highly improved.

Tint retention and chalking resistance were assessed with the results depicted in Tables 3a, 3b and 3c.

### Tint Retention

Samples of several of the compositions identified in Tables 1a and 1b were analysed with respect to tint retention, (alternatively referred to as color retention) the ability to maintain “as painted” color properties. The two alternative colors, used in the assessment were namely, Chromaflo Colortrend™ 888-7214 Phthalo Blue (Tables 3a and 3b) and Chromaflo Colortrend™ 888-1572 Brown oxide (Table 3c).

ΔE* Color measurements were conducted on initial samples (Ohr) followed by measurements after 1000, 2500, and 5000 hrs. of QUV aging in accordance with ASTM D2244 using a BYK-Gardner Spectro-Guide 45/0 colorimeter. ΔE* levels are the difference between the displayed color and the original color standard of the input content. ΔE* is measured on a scale from 0 to 100, where 0 is less color difference, and 100 indicates complete distortion. Lower Delta E figures indicate greater accuracy, while high Delta E levels indicate a significant mismatch.

### Chalking Resistance

Chalking resistance can be defined as the ability of a coating to resist the formation of a powdery (friable) powder on the surface of its film caused by the disintegration of the binding medium due to degradative weather factors. Chalking resistance was evaluated in accordance with ASTM D4214-07 and results were obtained after 5,000 QUV hrs. of accelerated aging.

TABLE 3a
Tint retention (ΔE*) and Chalking Resistance
after QUV accelerated aging of coatings containing
Chromaflo Colortrend ™ 888-7214 Phthalo Blue.

| | | | | Chalking (ASTM D4214) |
|---|---|---|---|---|
| | ΔE* after | ΔE* after | ΔE* after | (1 best - 5 worst) |
| | 1,000 hrs. | 2,500 hrs. | 5,000 hrs. | after 5,000 hrs. |
| C. 1 | 9.29 | 17.81 | 20.73 | 1 |
| C. 3 | 6.69 | 9.28 | 14.16 | 5 |
| Ex. 4 | 6.37 | 10.23 | 14.23 | 1 |
| Ex. 3 | 5.91 | 10.30 | 14.25 | 1 |

TABLE 3b
Tint retention (ΔE*) in field exposure series
at Spring House, PA. 5 wt % Phthalo Blue was utilized.
(Chromaflo Technologies Colortrend ™ 808-7055).

| | ΔE* after 24 months |
|---|---|
| C. 1 | 25.21 |
| C. 3 | 8.5 |
| Ex. 3 | 14.1 |
| Ex. 4 | 11.2 |
| Ex. 5 | 10.9 |

TABLE 3c
Tint retention (ΔE*) and Chalking Resistance
after QUV accelerated aging of coatings containing
Chromaflo Colortrend ™ 888-1572 Brown oxide.

| | | | | Chalking (ASTM D4214) |
|---|---|---|---|---|
| | ΔE* after | ΔE* after | ΔE* after | (1 best - 5 worst) |
| | 1,000 hrs. | 2,500 hrs. | 5,000 hrs. | after 5,000 hrs. |
| C. 1 | 0.20 | 2.08 | 2.28 | 1 |
| C. 3 | 5.11 | 4.49 | 4.45 | 5 |
| Ex. 2 | | | 0.89 | 1 |
| Ex. 3 | 1.88 | 0.47 | 0.85 | 1 |

For the respective blue and brown colors, the color rate for C. 1 shows the fastest degradation rate while C. 3 and Ex. 3 shows lower color degradation rate. The Ex. 3 has similar degradation rate as the C. 3 but significant improvement in chalking resistance. Therefore, the Ex. 3 shows both improved tint retention performance and the chalking resistance.

The mechanical properties of the films were determined. Measurements were conducted according to ASTM D412. Coating films were conditioned at 23° C. and 50% relative humidity for 7 days prior to testing and the results of the coatings tested are depicted in Table 4 below.

TABLE 4
Improvements in mechanical properties for Ex. 1 and Ex. 2 over comparatives C.
1 and C. 2 (ASTM D412) Average film thickness: 13 ± 1 mils (0.3302 ± 0.0254 mm).

| | C. 1 | C. 2 | Ex. 1 | Ex. 2 |
|---|---|---|---|---|
| Modulus @ 25% Elongation (MPa) | 0.54 ± 0.01 | 0.93 ± 0.06 | 0.62 ± 0.05 | 0.14 ± 0.03 |
| Modulus @ 50% Elongation (MPa) | 0.61 ± 0.01 | 1.28 ± 0.08 | 0.77 ± 0.05 | 0.19 ± 0.01 |
| Modulus @ 100% Elongation (MPa) | 0.69 ± 0.01 | 1.99 ± 0.09 | 1.00 ± 0.08 | 0.23 ± 0.02 |
| Tensile Strength (MPa) | 1.54 ± 0.10 | 7.89 ± 0.34 | 2.29 ± 0.14 | 0.54 ± 0.02 |
| Elongation at Break | 702 ± 84 | 385 ± 7 | 346 ± 22 | 420 ± 29 |

### Water Vapor Transmission

All coatings were drawdown to a film thickness of 12 mils (0.30 mm) and conditioned at 23° C. and 50% relative humidity for 7 days, after which water vapor transmission tests were conducted in accordance with ASTM F1249 using a MOCON™ (Minneapolis, MN) PERMATRAN-WTM model 3/33 MG Plus. Measurements were typically conducted at room temperature (about 23° C.) and 50% relative humidity and are provided in Table 5 below.

TABLE 5
Improved water vapor transmission for Examples (ASTM F1249).

| | C. 1 | C. 2 | C. 3 | Ex. 1 | Ex. 3 | Ex. 5 |
|---|---|---|---|---|---|---|
| Water Vapor | 744 | 137 | 343 | 355 | 572 | 391 |
| Transmission 7 day | | | | | | |
| dried (ng · s⁻¹ · m⁻² · Pa⁻¹) | | | | | | |
| Water Vapor | NM | 137 | NM | 360 | NM | NM |
| Transmission 1000 hr. | | | | | | |
| QUV (ng · s⁻¹ · m⁻² · Pa⁻¹) | | | | | | |

In the above Table 5 NM=not measured

In general, the water-borne (meth)acrylic resin emulsion coating compositions of the examples showed improved water-resistant properties and water vapor transmission of silicones in comparison to comparative examples 2 and 3.

Contact angle and water swell were also assessed and the results are provided in Table 6 below.

### Contact Angle Measurement:

Experiments were conducted at room temperature using a VCA Optima XE instrument and its corresponding software. A layer of coating composition was applied onto a substrate surface and 1 μm liquid drops were deposited on the surface of the relevant filmic coating using a syringe. Images of the drops were collected immediately after the water droplet touched the coating surface. Once the image was collected, we used the software to determine baseline and right, left and top edges of the droplet enabling the calculation of the contact angle. The left and right angle of the water contact were recorded and averaged over five measurements. Lower contact angle values

### Water Swell Measurements.

Water swell measurements were conducted according to ASTM D471. A piece of film was cut using a circular die of linch (2.54 cm) diameter. The dried film was weighed and placed inside a cup. Water was added (40 g) and closed. The absorption of water by the film was measured over the course of seven days.

TABLE 6
Water contact Angle and Water swell properties of a film made from
Ex. 1 formulation as compared to C. 1 and C. 2 formulations

| | C. 1 | C. 2 | Ex. 1 |
|---|---|---|---|
| Water Contact Angle | 88.0 | 29.0 | 90.0 |
| Water Swell (%) after 24 hrs (ASTM D471) | 6 | 20 | 12 |
| Water Swell (%) after 168 hrs (ASTM D471) | 3 | 16 | 8 |

In conclusion, this disclosure demonstrates large improvements in coating performance of water-borne (meth)acrylic resin emulsion coating compositions as a result of the provision of a new method for introducing high loadings (greater than 10 wt. %) of pre-prepared silicone rubber microparticles in water-borne (meth)acrylic resin emulsion coating compositions. This was achieved by mixing an aqueous (meth)acrylic resin emulsion with an aqueous dispersion of pre-prepared silicone rubber microparticles (a) (ii) prepared and not as has been previously attempted introducing the pre-prepared silicone rubber microparticles (a) (ii) into a composition of (meth)acrylic resin monomers before commencing emulsion polymerisation to generate an aqueous (meth)acrylic resin emulsion. This results in the water-borne (meth)acrylic resin emulsion coating compositions as described herein containing high loadings, i.e., much greater than 10 wt. % e.g., a 50/50 by wt. % of (meth)acrylic resin (a) (i) and pre-prepared silicone rubber microparticles (a) (ii); based on the total wt. % of (a) (i)+ (a) (ii) therefore a significantly greater proportion of pre-prepared silicone rubber microparticles (a) (ii) moving away from the typical additive ranges observed previously.

Hence, a method has been surprisingly identified how to combine the highly attractive silicone properties of UV-Resistance, durability, water vapor permeation, and water resistance with the acrylic properties of film formation, toughness, dirt pickup resistance, and pigment stability known in (meth)acrylic binders. Furthermore, the coating resulting from a water-borne (meth)acrylic resin emulsion coating composition as described herein is designed to be capable of forming a coating described herein and improves storage shelf-life as measured by a heat aged stability test where each week at 50° C. corresponds to ˜2 months at room temperature. Compositions herein achieved >16 weeks of heat aged stability, which corresponds >2 years of product storage shelf-life as defined by maintaining a viscosity of <55,000 mPa·s after ≥10 weeks of 50° C. A silicone/(meth)acrylic coating with balanced mechanical properties of tensile strength of >300 psi (2.068 MPa) and 350% elongation and have enabled high loadings of silicone rubber microparticles homogeneously dispersed in the (meth)acrylic matrix.

1. A water-borne (meth)acrylic resin emulsion coating composition comprising:
(a) a binder in an amount of from 30 to 70 wt. % of the water-borne (meth)acrylic resin emulsion coating composition, the binder comprising;
(a) (i) a (meth)acrylic resin in an amount of from 20 to 80 wt. %, and
(a) (ii) pre-prepared silicone rubber microparticles in an amount of from 20 to 80 wt. %;
each based on the total wt. % of (a) (i)+ (a) (ii);
(b) an aqueous liquid continuous phase in an amount of from 15 to 30 wt. % of the water-borne (meth)acrylic resin emulsion coating composition;
(c) one or more surfactants in an amount of from 0.5 to 5 wt. % of the water-borne (meth)acrylic resin emulsion coating composition; and
(d) one or more additives.

2. The water-borne (meth)acrylic resin emulsion coating composition in accordance with claim 1, wherein the (meth)acrylic resin (a) (i) has a glass transition temperature (Tg) from −50 to 100° C.

3. The water-borne (meth)acrylic resin emulsion coating composition in accordance with claim 1, wherein the binder (a) is present in an amount of from 40 to 60 wt. % of the waterborne (meth)acrylic resin emulsion coating composition.

4. The water-borne (meth)acrylic resin emulsion coating composition in accordance with claim 1, wherein the binder (a) comprises:
the (meth)acrylic resin (a) (i) in an amount of from 20 to 60 wt. %; and
the pre-prepared silicone rubber microparticles (a) (ii) in an amount of from 40 to 80 wt. %;
each based on the total wt. % of (a) (i)+ (a) (ii).

5. The water-borne (meth)acrylic resin emulsion coating composition in accordance with claim 1, wherein component (d) is selected from one or more of inorganic fillers, pigments and/or colorants and/or dyes, rheology modifiers, thickeners, defoamers, oxidants, reducing agents, chain transfer agents, neutralizers, dispersants, curing agents, buffers, corrosion inhibitors, neutralizers, humectants, fire retardants, wetting agents, UV absorbers, fluorescent brighteners, light or heat stabilizers, biocides, mildewcides, fungicides, algaecides, and combinations thereof, waxes, water-repellants, extenders, anti-oxidants, coalescing agents, preservatives and/or freeze/thaw additives.

6. A coated substrate, which substrate is coated with a coalesced film formed after application of the water-borne (meth)acrylic resin emulsion coating composition in accordance with claim 1 onto a substrate.

7. A method of making the water-borne (meth)acrylic resin emulsion coating composition in accordance with claim 1, the method comprising:
mixing an aqueous (meth)acrylic resin emulsion comprising;
a (meth)acrylic resin (a) (i), and
a surfactant,
in an aqueous liquid continuous phase with
an aqueous dispersion of pre-prepared silicone rubber microparticles (a) (ii) comprising the pre-prepared silicone rubber microparticles (a) (ii) in the presence of
one of more surfactants
in an aqueous liquid continuous phase;
wherein one or more additives are added into either the aqueous (meth)acrylic resin emulsion, the aqueous dispersion of pre-prepared silicone rubber microparticles (a) (ii) or both prior to mixing and/or are added to the water-borne (meth)acrylic resin emulsion coating composition after the aqueous (meth)acrylic resin emulsion and the aqueous dispersion of pre-prepared silicone rubber microparticles (a) (ii) have been mixed together.

8. The method of making the water-borne (meth)acrylic resin emulsion coating composition in accordance with claim 7, wherein the aqueous (meth)acrylic resin emulsion is the product of the preparation of the (meth)acrylic resin (a) (i) by emulsion polymerisation.

9. The method of making the water-borne (meth)acrylic resin emulsion coating composition in accordance with claim 7, wherein the aqueous dispersion of pre-prepared silicone rubber microparticles (a) (ii) is the product of the preparation of the pre-prepared silicone rubber microparticles (a) (ii).

10. The method of making the water-borne (meth)acrylic resin emulsion coating composition in accordance with claim 7, comprising the steps of:
(I) preparing a (meth)acrylic resin water-borne emulsion by emulsion polymerization of a (meth) acrylate monomer selected from the group of an acrylic ester, a methacrylic ester or a mixture thereof in an aqueous liquid continuous phase (b) in the presence of a surfactant (c);
(II) preparing an aqueous dispersion of pre-prepared silicone rubber microparticles (a) (ii) in an aqueous liquid continuous phase (b) by stirring the pre-prepared silicone rubber microparticles (a) (ii) in the aqueous liquid continuous phase in the presence of one of more surfactants (c);
(III) mixing the resulting products of steps (I) and (II) in a predefined ratio to form a final water-borne (meth)acrylic resin emulsion coating composition; and
(IV) introducing one or more additives into either the aqueous (meth)acrylic resin emulsion, the aqueous dispersion of pre-prepared silicone rubber microparticles (a) (ii) or both prior to mixing and/or adding one or more additives to the water-borne (meth)acrylic resin emulsion coating composition after the aqueous (meth)acrylic resin emulsion and the aqueous dispersion of pre-prepared silicone rubber microparticles (a) (ii) have been mixed together.

11. The method of making a water-borne (meth)acrylic resin emulsion coating composition in accordance with claim 7, wherein the additives (d) are selected from one or more of inorganic fillers, pigments and/or colorants and/or dyes, rheology modifiers, thickeners, defoamers, oxidants, reducing agents, chain transfer agents, neutralizers, dispersants, curing agents, buffers, corrosion inhibitors, neutralizers, humectants, fire retardants, wetting agents, UV absorbers, fluorescent brighteners, light or heat stabilizers, biocides, mildewcides, fungicides, algaecides, and combinations thereof, waxes, water-repellants, extenders, anti-oxidants, coalescing agents, preservatives and/or freeze/thaw additives.

12. A water-borne (meth)acrylic resin emulsion coating composition obtainable in accordance with the method of claim 7.

13. (canceled)

14. (canceled)

15. (canceled)
